(19) United States
(12) Patent Application Publication
(10) Pub. No.: US 2018/0048085 A1
(43) Pub. Date: Feb. 15, 2018

(54) Electrical cord connectors, adapters, adaptable replacement connectors, non-wired fittings, and a Christmas light socket clip

(71) Applicant: Cosimio Fuda, Toronto (CA)

(72) Inventor: Cosimio Fuda, Toronto (CA)

(21) Appl. No.: 15/629,733

(22) Filed: Jun. 21, 2017

Related U.S. Application Data
(60) Provisional application No. 62/352,886, filed on Jun. 21, 2016.

(51) Int. Cl. H01R 13/44; H01R 13/64; H01R 24/28; F21V 23/06; H01R 31/06; F21S 4/10; F21V 21/088; H01R 24/20; H01R 25/00

(52) U.S. Cl. CPC H01R 13/44; H01R 24/20; H01R 13/64; H01R 24/28; H01R 25/003; H01R 31/06; F21S 4/10; F21V 21/088; F21V 23/06; F21W 2121/00

(57) ABSTRACT

The present invention relates to electrical cords and more specifically to electric cord connectors for various uses, including holiday lighting, that allows Christmas light strings to be installed with either end of the cord connectors at the power source. A connector can include a receiving port for a corresponding connector. Both male and female connectors of the present invention, can be manufactured on the electric cords or can include individual replacement type connectors or adaptable replacement connectors. Cords with just a first and second female connector are coupled together and the aligned contact slots are linked with a linking male fitting. An adapter cord powers up the these cords with an activating male fitting. The improved cords, used for holiday lighting, such as Christmas, also includes an improved Christmas light socket with clip, wherein the light socket is one half of the clip and an elongated body member is the other half, resulting in an improved clip with less parts that can be broken.

### FIELD

This present invention relates to electrical cords and more specifically to electric cord connectors.

### BACKGROUND

Electrical cords connect to power sources through male plugs into female electrical sockets, and electric cords can be extended through a female receptacle connector of one cord connecting to a male plug connector of another cord. However, electrical cords and their connectors, are sometimes mounted or installed in reverse, or these electrical connectors get damaged and require replacing. For example, electrical cord connectors on outdoor Christmas lighting on occasion are installed in reverse, with the male plug furthest away from the power source. When this happens, to operate the lights safely the Christmas light strings should be taken down and installed with the connectors in the correct position. An unsafe option is to create a double male plug by cutting off the female receptacle connector at the power source location and installing a male plug in its place, but this creates a very dangerous electrical hazard at every male connection.

The contents of all of these patents and published applications are hereby incorporated by reference. Various modifications and combinations have been envisaged for electrical plugs, receptacles, adapters and combinations therein, as set out in U.S. Pat. Nos. 5,232,381, 4,904,195 and 9. U.S. Pat. No. 7,029,312 describes a cord with two male plug ends for use when a cord ends in a female connector receptacle, for example, if a cord, such as a string of Christmas lights, has a female connector receptacle at the point at which the cord needs to plug into a female electrical socket.

It is an object of this invention to provide an improved electrical cord for easily installing holiday lighting with the connector of either end of the cord at the intended power source/receptacle.

It is also another object of the present invention to provide an improved mounting clip for installing various holiday lighting, such as Christmas light strings.

It is also another object of the present invention to provide an adaptable replacement connector that is easier to repair when damaged, saving time and money.

Another object of this invention is to apply the concept of the female connector with contact slots continuous and open from the back for other applications, possible for RV and generator hookups.

### SUMMARY

In accordance with the first aspect of the present invention, there is provided various electrical cords manufactured with a “male and female” connector end or a cord sets with just “female” connectors linked with a linking male fitting, (a hot blade and a neutral blade), that not is not electrically wired. Both types of cord sets include at least one connector with a receiving port, sized for the corresponding connector on the other end of the cord and an adapter with an activating male fitting. The receiving port provides the safety feature to operate these electrical cord sets more safety, for various uses, including for indoor or outdoor. A power adapter cord is needed to power these cords, and includes the both corresponding connector of that cord set along with the fourth female connector with activating male fitting. These cords and adapters allow Christmas light strings to be installed or mounted in either direction, and with either connector end of the cord at the power receptacle. A splitter adapter cord is also provided to installs to connect multiple cords to run in different directions. The splitter and power adapter cords can also include an on/off switch and the power adapter can also include a built-in GFCI breaker.

The cord with just “female” connectors, includes the second female connector comprising an electrical receptacle with a hot and neutral contact slot and the third female connector comprising a hot and neutral contact slots that are continuous and open to the receiving port below. The linking male fitting is inserted into both connectors to complete the connection. The power adapter cord with activating male fitting can be used for both cord sets, to safely power them.

These connectors mentioned above, can also be manufactured as replacement connectors to replace conventional male and female connectors, to save existing cords or to replace a connector when it becomes damaged.

Another aspect of the present invention, is an improved Christmas light clip that acts as a conventional type clip, but has less parts because the light socket acts as one half of the clip. Also the improved Christmas light clip(s) can include a rubber boot or cover to protect the spring from damaged caused by various weather conditions or other.

A further aspect of the present inventions provides an adaptable replacement male or female connector, or an adaptable replacement female connector, can be used to repair various electrical cords when the become damaged. An adaptable replacement connector comprises of common internal electrical components, such as an inner housing, housing the contact slots with combined wire terminals. A adaptable male replacement connector comprises a top cover with a male fitting and a corresponding mounting base. The male fitting comprises a hot blade, a neutral blade and a ground prong, and the male fitting can easily be replaced if any of the blades or ground prongs become damaged without requiring any re-wiring of the connector.

An adaptable female replacement connector comprises of the same internal electrical components, such as the inner housing, housing the contact slots/wire terminals and the corresponding female receptacle cover with mounting base.

The adaptable replacement connector, either female or male, can save time and money, by not replacing the connector completely and can be applied to applications such as a 3 way splitter or multiple plug adapter.

The concepts mentioned above can be applied to various applications.

### BRIEF DESCRIPTION OF THE FIGURES

For better understanding these and other aspects of the present invention will be apparent from the brief description of the drawings and the following detailed description in which:

FIG. 1a shows a top perspective view of a first embodiment of a female connector and a first embodiment of a male connector of the present invention on the respective ends of a string of Christmas lights.

FIG. 1b shows a bottom perspective view of the first female connector of FIG. 1a.

FIG. 1c shows a bottom perspective view of the first embodiment male connector of FIG. 1a.

FIG. 2a shows a side perspective view of an embodiment of a second female connector and a third female connector of the present invention on the respective ends of a string of Christmas lights.

FIG. 2b shows a bottom perspective view of the second female connector of FIG. 2a.

FIG. 2c shows a bottom perspective view of the third embodiment female connector of FIG. 2a.

FIG. 2d shows a side perspective view of a first linking male fitting for connectively linking the contact slots of the second and third female connectors of separate Christmas light cords together of FIG. 2a.

FIG. 2e is bottom perspective view of the first linking male fitting of FIG. 2d.

FIG. 2f a end view of the first linking male fitting of FIGS. 2d and 2e.

FIG. 2g shows a perspective view of two string of Christmas lights, with a first linking male fitting attached on one end of one string of lights.

FIG. 3 shows the embodiments of the first female connector and first male connector of FIG. 1a of multiple cords, aligned together.

FIG. 4a shows the second female connector of the present invention of one cord connected to the third female connector of the present invention of another cord.

FIG. 4b shows a side perspective view of the first linking male fitting of FIGS. 2d-2f.

FIG. 4c shows the first linking male inserted into the aligned contact slots of the second and third female connectors.

FIG. 5a shows a side perspective view of an alternative second linking male fitting with an additional component of a light socket connector cap.

FIG. 5b is a cross-sectional view of the second linking male fitting of FIG. 5a.

FIG. 5c shows a bottom perspective view of a third linking male fitting with a an additional component of a female connector cap.

FIG. 5d is a cross-sectional view of the third linking male fitting of FIG. 5c.

FIG. 6a shows a side perspective view of a first embodiment of a power adapter cord comprising the first female connector and the first male connector of FIG. 1a, each connected to a cord through a splitter, that is further connected to a fourth embodiment female connector. The power adapter cord also includes a detached first activating male fitting to-plug-into a live receptacle an power the adapter cord and any cords connected to it.

FIG. 6b shows an second embodiment of a power adapter cord comprising the second and third female connectors of FIG. 2a, each connected to a cord through a splitter, that is further connected to the fourth embodiment female connector of FIG. 6a and includes the first activating male fitting of FIG. 6c to power the adapter cord.

FIG. 6c shows a perspective view of the fourth female connector and the first activating male fitting of the present invention.

FIG. 6d shows a back perspective view of the fourth embodiment female connector of FIGS. 6a and 6b.

FIG. 6e shows a front perspective view of the first activating male fitting of FIGS. 6a and 6b.

FIG. 6f shows a perspective view of the first activating male fitting inserted into the fourth female connector.

FIG. 7a shows the first embodiment power adapter cord with activating male fitting connected to the weatherproof cover and electrical receptacle and plugged into the outdoor electrical receptacle of FIG. 7b.

FIG. 7b shows a perspective view of an outdoor electrical box with receptacle, an outdoor weatherproof cover, and the first activating male fitting.

FIG. 8 shows a first embodiment of a splitter adapter of the present invention comprising the first female and first male connectors from FIG. 1a, connected to a splitter, that is connected to a further first female connector from FIG. 1a.

FIG. 9 shows a second embodiment splitter adapter comprising the second female connector and the third female connector from FIG. 2a, connected to a splitter, that is connected to a further second female connector of FIG. 2a.

FIG. 10a shows a front perspective view of two halves of a first embodiment Christmas light socket with clip.

FIG. 10b shows an exploded view of the first embodiment Christmas light socket with clip.

FIG. 10c shows a perspective back view of the first embodiment Christmas light socket with clip of FIG. 10b.

FIG. 10d shows a side perspective view of the Christmas light socket with clip of FIG. 10b.

FIG. 11a shows a front perspective view of the two halves of a second embodiment Christmas light socket with clip.

FIG. 11b shows an exploded view of the second embodiment Christmas light socket with clip.

FIG. 11c shows a perspective back view of the second embodiment Christmas light socket with clip of FIG. 11b.

FIG. 11d shows a side perspective view of the Christmas light socket with clip of FIG. 11b.

FIG. 12a shows an exploded view of a first adaptable replacement male connector comprising a removable cover with male prongs and a removable first mounting base.

FIG. 12b shows a side perspective view of the adaptable replacement connector cover with male prongs of FIG. 12a.

FIG. 12c shows a front perspective view of the adaptable male replacement connector of FIG. 12a with an electrical cord wired to it.

FIG. 13a shows a top perspective view of a female receptacle cover with a second mounting base for use with the first adaptable replacement connector of FIG. 12a.

FIG. 13b shows a perspective view of the inside of the female cover of FIG. 13a.

FIG. 13c shows the adaptable female replacement connector with cover and mounting base connected to on an end of an electrical cord.

FIG. 14a shows a back side perspective view of an embodiment of a first connector adapter.

FIG. 14b shows a front side perspective view of the first embodiment connector adapter of FIG. 14a.

### DETAILED DESCRIPTION OF THE INVENTION

The electrical connectors of the embodiments of the present invention comprise of various improvements of electrical female and male connectors. (The second and third female connectors align together and a non wired male fitting fits over the aligned connectors to link the contact slots together). Also, a conventional female connector with a hot and neutral contact slot, namely a hot and neutral contact with a continuous opening for various male fittings, comprising a hot blade and a neutral blade, are utilized in this invention. Both conventional female and male connectors may be adapted with a receiving port to receive the corresponding female or male connector, for various uses, including holiday lighting. For simplicity and understanding of the present invention, various male connectors and male fittings may be referred to having blades or prongs and the mentioning of “blades or prongs” should be understood to have the same meaning for purposes of understanding the invention.

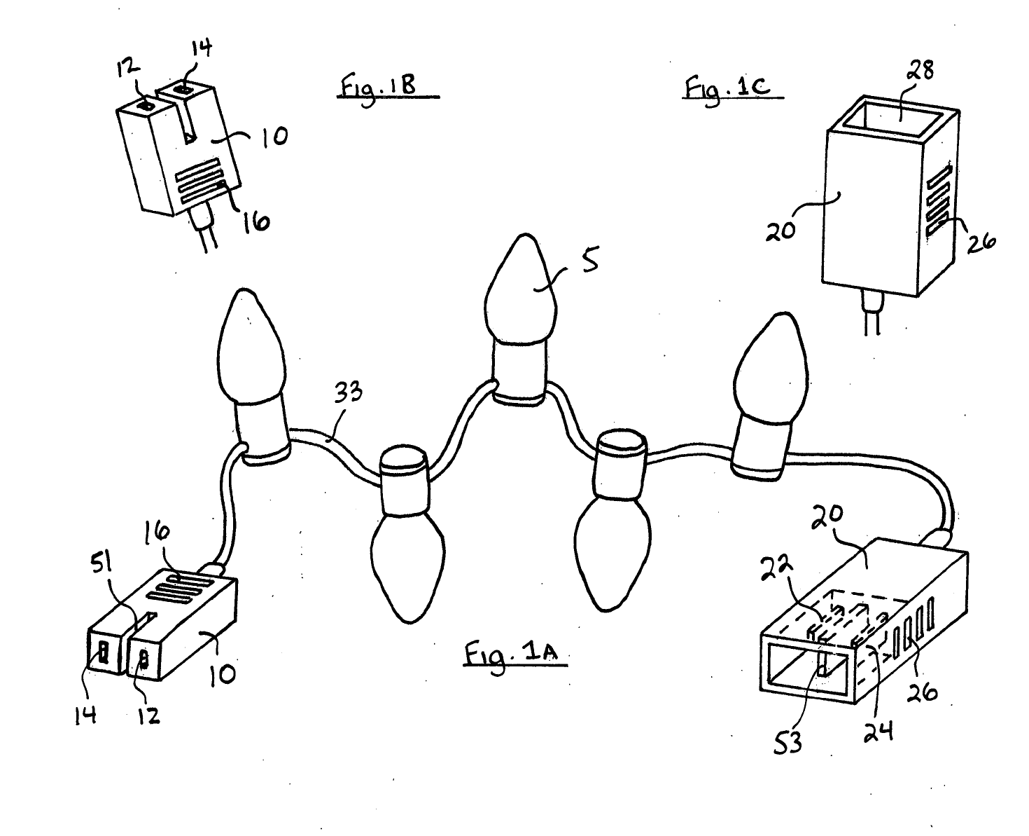

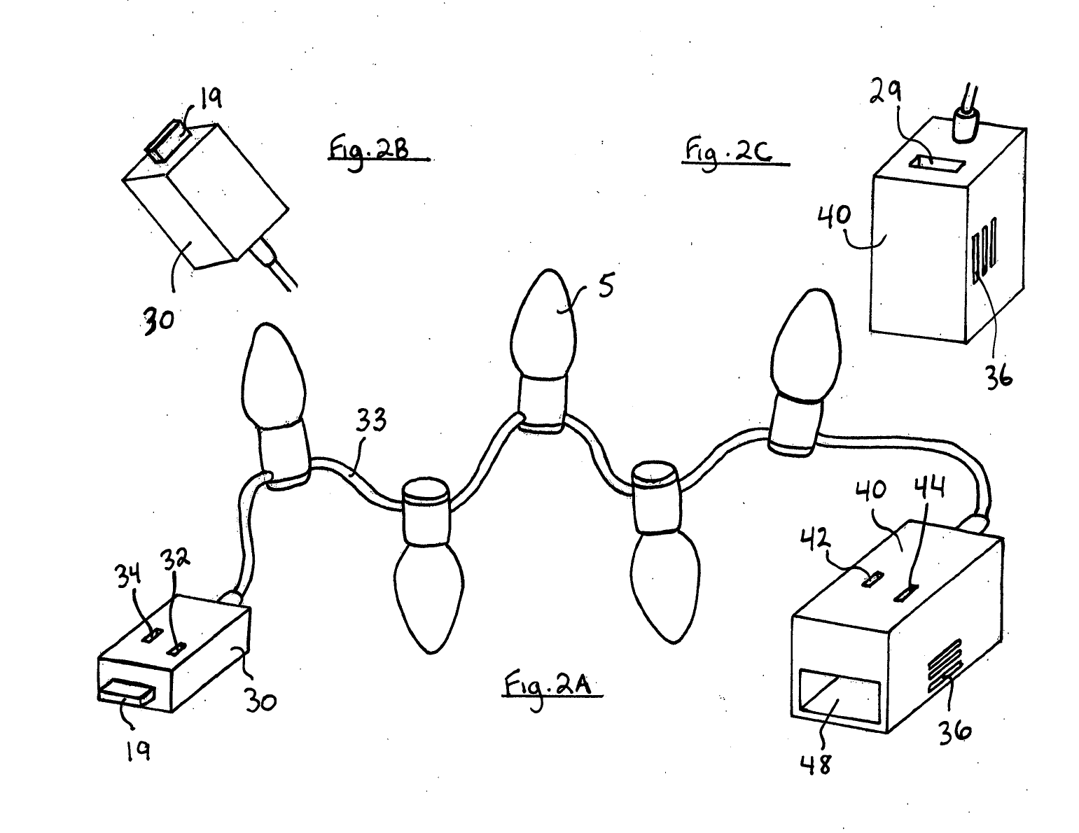

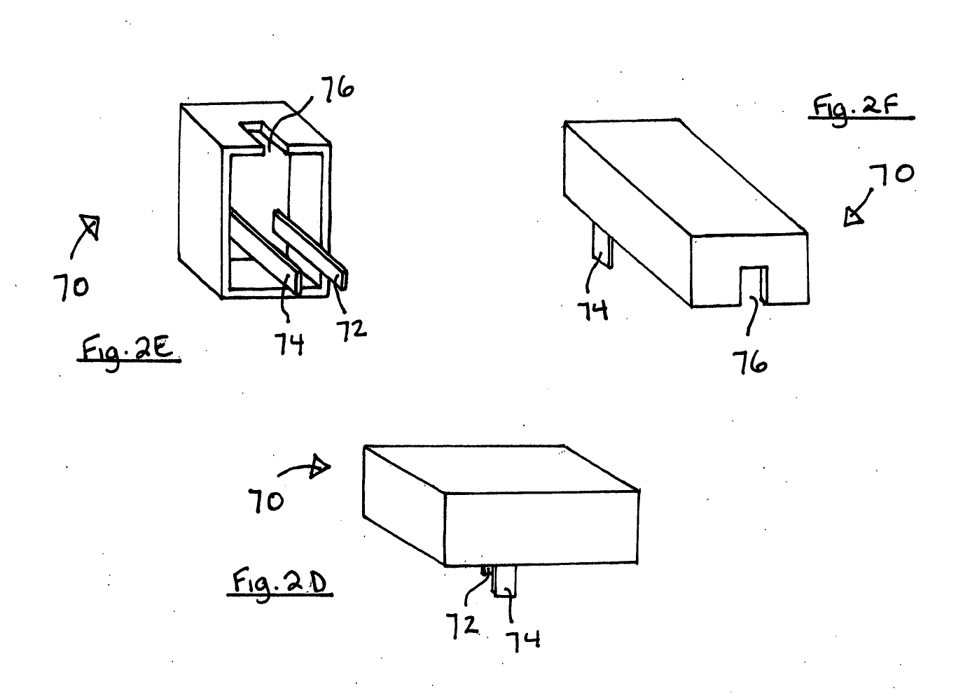

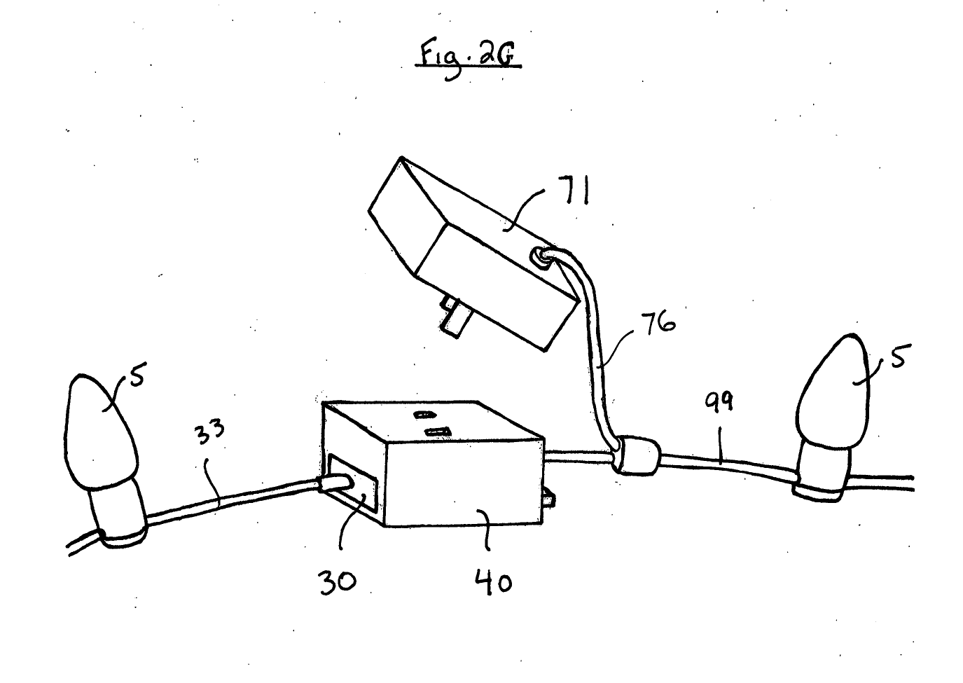

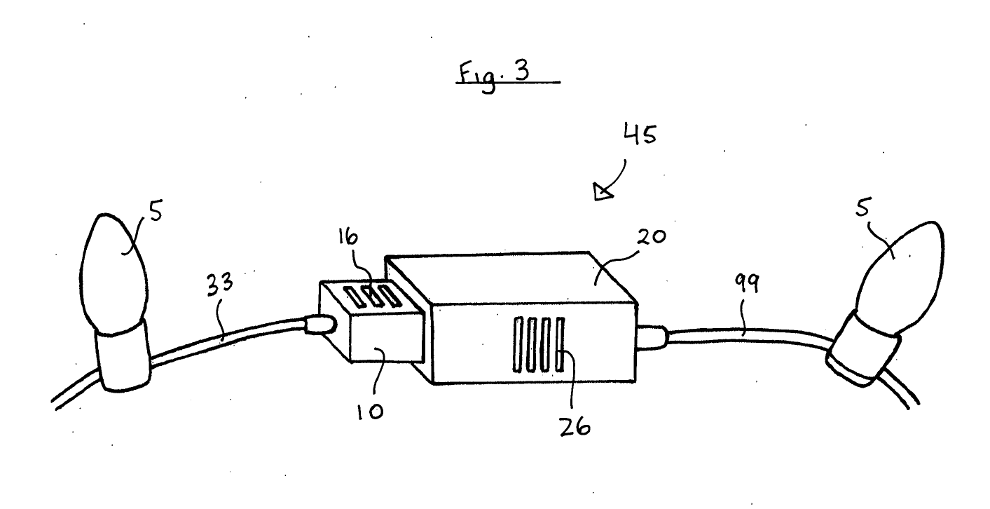

FIGS. 1 and 2 show two types of cord sets with special connectors that can be used for holiday lighting. Other figures below describe special adapters to provide power to these cords.

FIG. 1a shows a string of Christmas lights 5 with embodiments of a first female connector 10 on a first end and a first male connector 20 on a second end of the cord 33, of the present invention. FIG. 1a shows the first female connector 10 with a one piece molded outer housing (an enclosed first housing), which has an electrical receptacle comprising a first hot contact slot 12, and a first neutral contact slot 14 on the end of the connector 10. The first housing may optionally comprise first grips 16 for gripping. A slot 51 in the first female connector 10 corresponds to a protective partition 53 of the first male connector 20.

The first male connector 20, comprises a one piece molded outer housing (a second housing), with a first hot blade slot 22, and a first neutral blade 24 within a receiving port 28. The connector's blades are recessed further back from the entry of the receiving port 28 and the protective partition 53 separates the hot and neutral blade, and acts as a safety feature to make physical contact with the blades more difficult. Optionally the second housing may comprise second grips 26 for gripping and separating the two connectors. Optionally, a string of Christmas lights 5 on cord 33, could have ends with multiple first female connectors or multiple first male connectors or a combination of both.

FIG. 1b shows the bottom of the first female connector 10 with first hot slot 12 and first neutral slot 14. First grips 16 are provided.

FIG. 1c shows a bottom perspective view of the first male connector 20, with receiving port 28 and second grips 26.

For simplicity, like components are give the same reference numerals.

FIG. 2a shows a string of Christmas lights 5 with an embodiment of a second female connector 30 and an embodiment of a third female connector 40 of the present invention. The second female connector 30 is shown wired to a first end of the string of Christmas lights 5 and the third female connector 40 is shown wired to the second end. FIG. 2a shows that the second female connector 30 with a one piece molded outer housing (an enclosed third housing), has an electrical receptacle on the top of the connector, comprising a third hot contact slot 32, and a third neutral contact slot 34. A tab 19 is located on the free end the second female connector 30 to correspond to a slot 29 in the back of the third female connector 40.

The third female connector 40 comprises a one piece molded outer housing (a fourth housing), with a third electrical receptacle having a third hot contact slot 42, a third neutral contact slot 44, that are continuously opened to the receiving port 48 below. The receiving port 48 is partly closed on the other end, and includes a slot opening 29 (not visible). The partly closed end acts as a stop when receiving the second female connector 30 to align both connectors and their contact slots to form the contiguous hot contact slot and the contiguous neutral contact slot. The slot opening 29 on the end of female connector 40, allows the tab 19 on the end of the second female connector to be pushed in while holding onto the third female connector 40 when separating the two connectors apart. Optionally the housing may comprise third grips 36 for gripping.

FIG. 2b shows the bottom of the second female connector 30 of FIG. 2a, with no access to the receptacle contact slots from the back (bottom). The second female connector 30 acts like a conventional receptacle. A tab 19 is located on the free end the second female connector 30.

FIG. 2c shows a bottom perspective view of the third female connector 40 of FIG. 2a. A slot 29 is located at the back of the receiving port 48 (not visible). Third grips 36 are located on the sides of the connector.

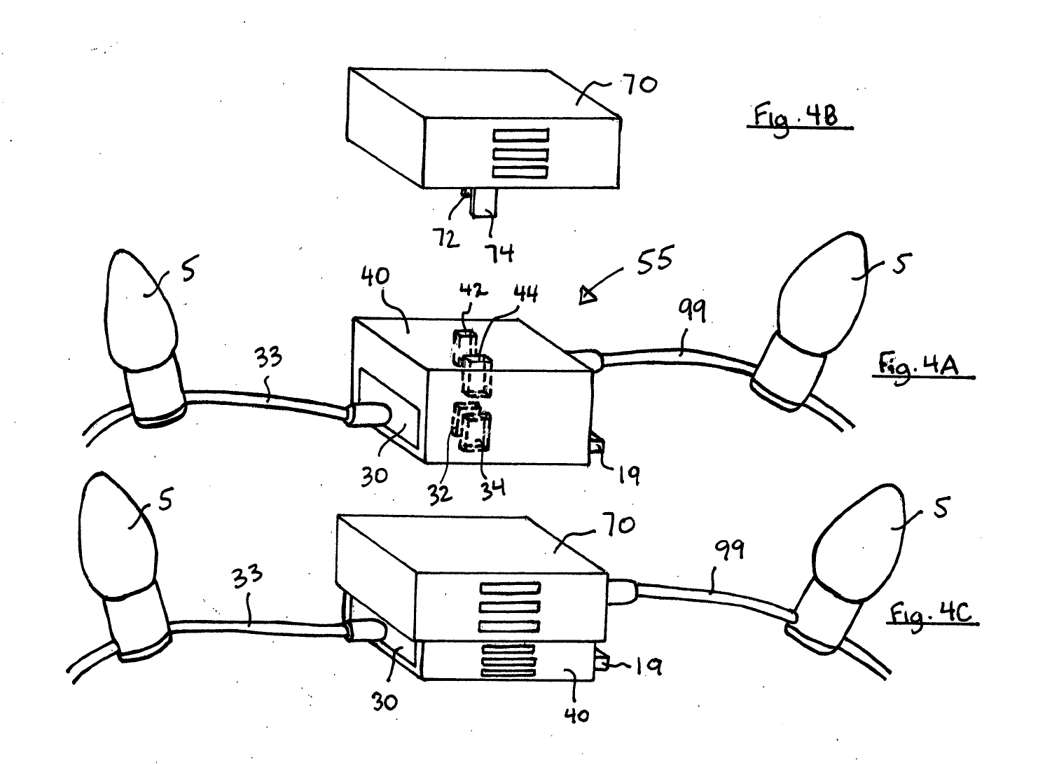

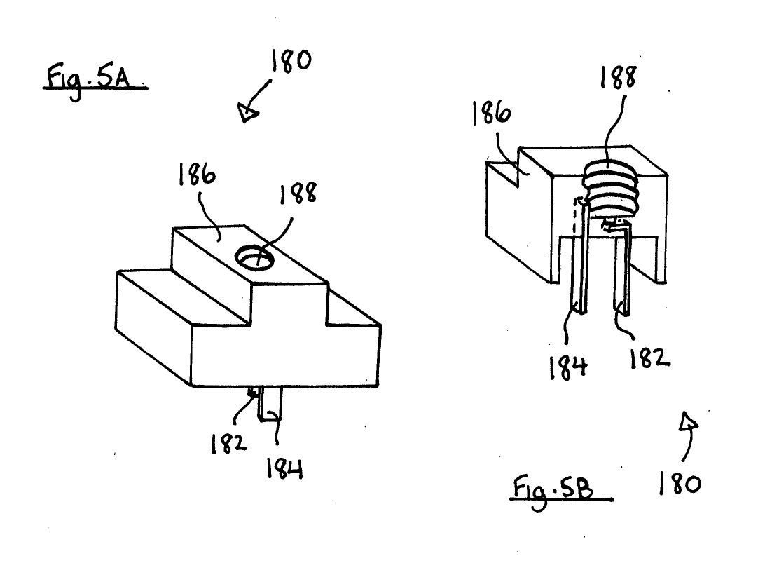

FIG. 2d-2f shows an embodiment of a first linking male fitting 70 with a hot blade/prong 72 and a neutral blade/prong 74. The linking male fitting 70, comprises of a box-shaped housing, with a top and four sides. The hot blade 72 and the neutral blade 74 are secured to the top inside of the male fitting. The hot blade 72 and neutral blade 74 are longer than conventional blades of a conventional male plug. When a second female connector 30 is inserted and aligned with the third female connector 40 of another cord (shown in FIG. 4a), a linking male fitting 70 is inserted into both female connectors and their contact slots, linking them together. A first cord slot opening 76 is provided to avoid the wired connector 40 (not shown).

FIG. 2g shows that a first linking male fitting 71 can be attached by a non wired cord 76 or the like, on the end of the string of Christmas lights 5, for ease of access to link the aligned second and third female connectors, 30 and 40 respectively of cord 33 and 99, respectively. If the cord 99 is powered, the first linking male fitting 71, which is not wired, will not be live until inserted into a connector.

A cord or strings of lights can have ends with multiple second or third female connectors or a combination of both. For ease of access, various linking male fittings of the present invention can be secured to one end of the cord for ease of access.

All figures of 1 and 2 can be designed with or without polarized connectors. Polarized connectors would be preferred for safely operating the electrical cords and preventing physical injury.

For the purposes of this application, most references to male fittings, including linking and activating male fittings of the present invention, comprise of an open box-shaped housing, which when used correctly should prevent any physical contact with the hot and neutral blades or any ground prong of a grounded connector, when an electrical connection is being made or disconnected. All male fittings in this application are not wired, and can be designed to almost completely enclosed the second female connector, other than the bottom and the cord entry slots.

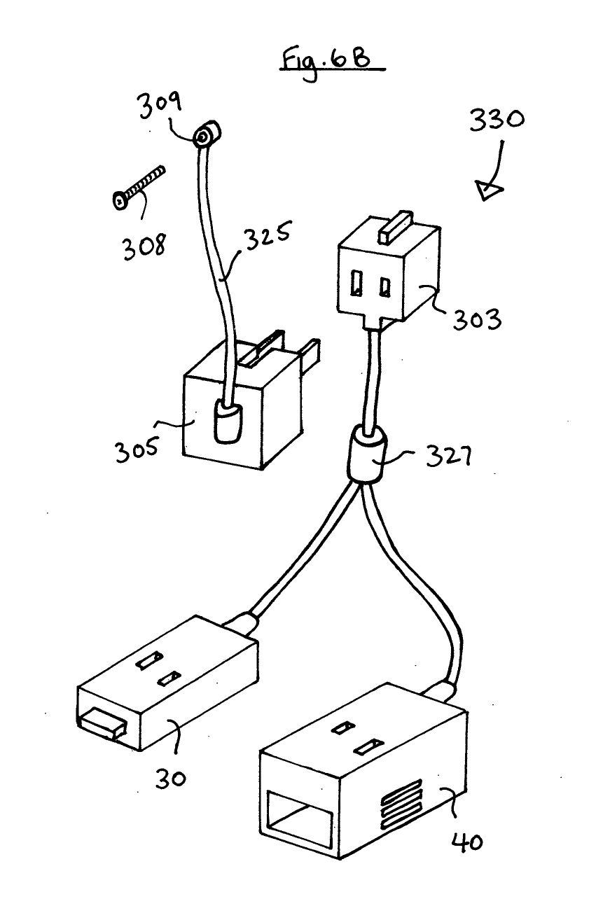

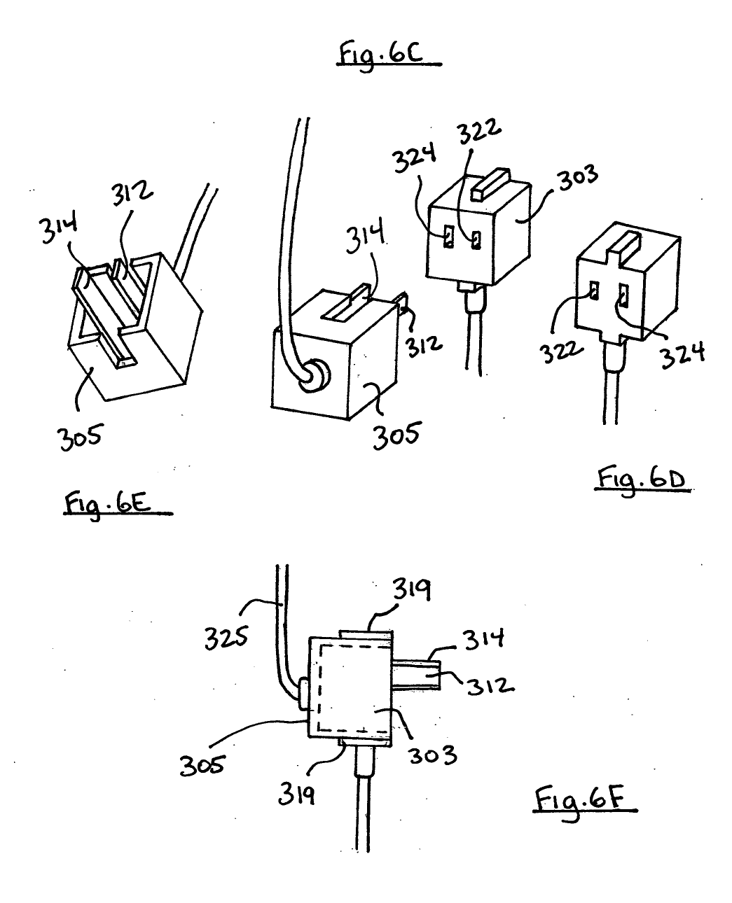

FIG. 3 shows the first female connector 10 of cord 33 of a string of Christmas lights 5, inserted into the receiving port of the first male connector 20 of cord 99 of a string of Christmas lights 5. A connection 45 is formed, with the first female connector enters the receiving port of first male connector 20, and the contact blades of connector 20 enter the contact slots of connector 10. First grips 16 of connector 10 and second grips 26 of connector 20 are shown. A power adapter 320 (shown in FIG. 6a) is needed to power up cords 33 and 99.

FIG. 4a shows the second female connector 30 of cord 33 of Christmas lights 5, fully inserted and aligned in the receiving port 48 (covered by connector 30) of the third female connector 40 of cord 99 of Christmas lights 5. The second female connector 30 slides into the third female connector 40 until it stops to align both connectors 55. The contiguous slots are formed by the aligned hot contact slot 32 with the hot contact slot 42, and by the aligned third neutral contact slot 34 with the third neutral contact slot 44. In FIG. 4a, the connectors are not linked until a linking male fitting 70 of FIG. 4b of the present invention is utilized, capping the connectors 55 at FIG. 4c. A power adapter 330 (not shown) is required to power cords 33 and 99.

FIGS. 4b and 4c shows the first linking male fitting and how it is used to link the connectors of FIG. 4a. FIG. 4b shows a first linking male fitting 70 of FIGS. 2d-2f, ready to be inserted into the aligned connectors 55 of FIG. 4a. via the hot blade 72 entering within the contiguous hot contact slots 42 and 32 and the neutral blade entering within the contiguous neutral contact slots 44 and 34. The connectors 55 are linked and connected when the first linking male fitting 70 caps the aligned connectors 55, as shown in FIG. 4c. An electrical connection is formed when either end of cords 33 or 99, located at the power source, and having either the second female connector 30 or third female connector 40 on that end of the cord, that connector is then connected to a power adapter 330 and plugged into that power source. (described in more detail in later figures of this application).

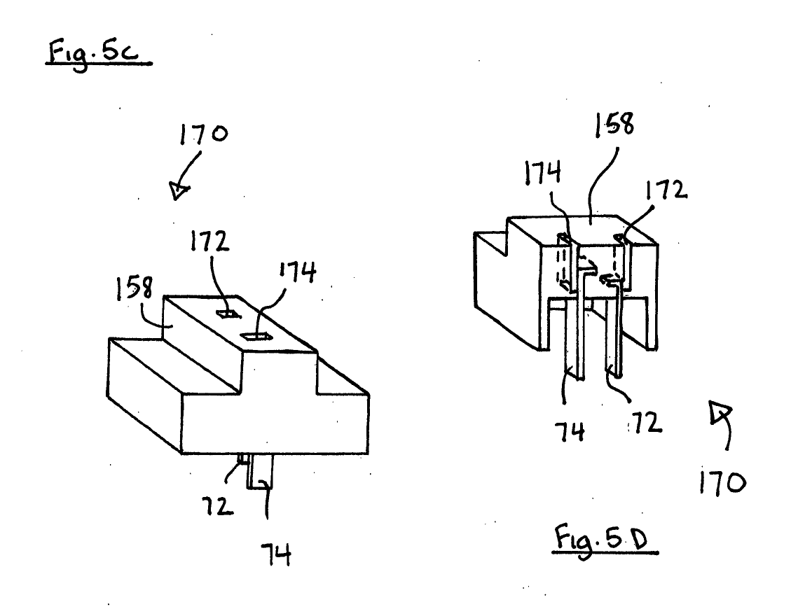

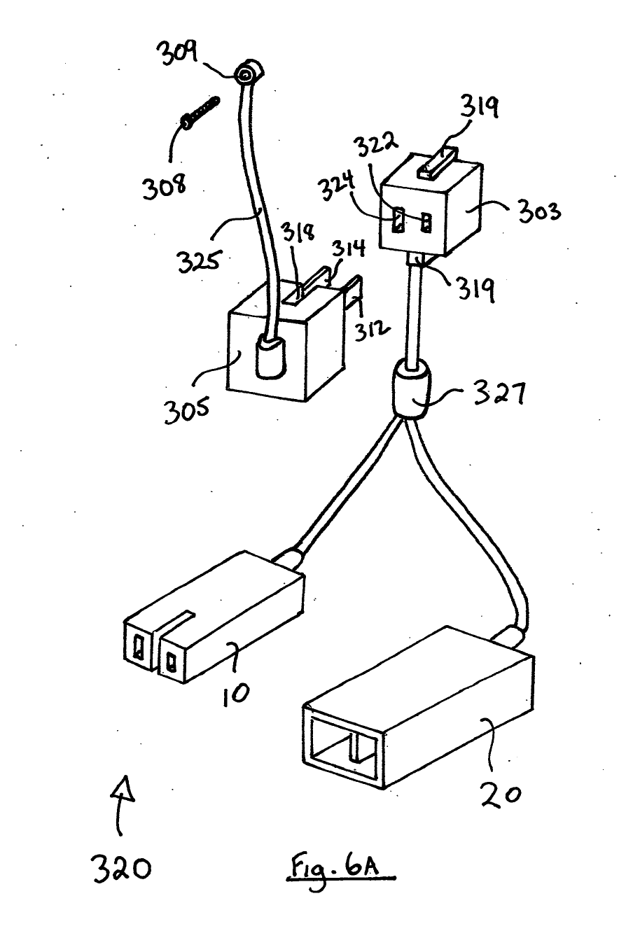

FIG. 5a shows a the second linking male fitting 180 comprising a hot blade 182, a neutral blade 184, additionally connected to a light socket 188 mounted of the top cap 186 of the male fitting.

FIG. 5b shows a cutout view of the second linking male fitting 180, showing the hot blade/prong 182 and the neutral blade/prong 184 connected to the bottom and side respectively of the light socket 188, of the cap 186 mounted to the top of the second linking male fitting.

FIG. 5c shows a third linking male fitting 170 with a female connector cap 158 having a hot contact slot 172 and a neutral contact slot 174 which join connectively with hot blade 72 and a neutral blade 74, respectively. It will be understood that this adaption of a female connector cap could be applied to all of the activating male fittings as well.

FIG. 5d shows a cutout view of the third linking male fitting 170, showing the hot blade/prong 72 and the neutral blade/prong 74 connected to the hot contact slot 172 and the neutral contact slot 174, respectively, of the female connector cap 158 located on the top of the third linking male fitting.

FIG. 6a shows a first embodiment power adapter cord 320 with a fourth female connector 303 wired to the splitter 327, that splits to a wired first female connector 10 and a wired first male connector 20, and the adapter 320 includes a first activating male fitting 305. The fourth female connector 303 includes a hot contact slot 322 and a neutral contact slot 324, and the contact slots are continuous and open from the back of the connector 303 (shown in FIG. 6d). The first activating male fitting 305 includes a hot blade 312 and a neutral blade 314. As will be self-evident, the blades of activating male fittings will are longer that normal to form what appears to be a conventional male plug when inserted into the fourth female connector 303. The power adapter cord 320 powers the string of Christmas lights 5 of FIG. 1a regardless of which connector 10 or 20 of the present invention is closest to the power outlet. The first activating male fitting 305, includes a slot opening 318, and connector 303 includes grips 319. Grips 319 are used to grab both connector 303 and activating male fitting 305, when both are engaged at the power outlet. The activating male fitting 305 also includes a strap 325 connected the fitting, and the other free end of the strap includes a mount with mounting hole 309 and screw 308. The first activating male fitting 305, acts as a safety feature to connect directly to an outdoor weatherproof cover and/or to a receptacle/power outlet 128. The strap 325 when used correctly tries to avoid using two power adapters and activating male fittings at both ends of the Christmas lights to avoid a hazard of creating a double male plug. A conventional male plug can be used to replace the fourth female connector and the first activating male fitting 305 of the power adapter 320, but may not be as safe in avoiding a male plug at both ends if two adapters were attempted to be used, one on the end of cord 33 and the other on cord 99.

FIG. 6b shows a second embodiment power adapter cord 330, also with a fourth female connector 303 wired to a splitter 327 that splits to a wired to the second female connector 30 and a wired third female connector 40, and the adapter 330 includes the first activating male fitting 305. The power adapter cord 330 powers the string of Christmas lights 5 (not shown) of FIG. 2a regardless of which connector, 30 or 40 of the present invention is closest to the power outlet. Again, the activating male fitting 305 also includes a strap 325 connected the fitting, and the other free end includes a mount with mounting hole 309 and screw 308. The first activating male fitting 305, should be secured and used as mentioned in FIG. 6a for safety.

FIG. 6c-6f shows the first activating male fitting 305 and the fourth female connector 303 of power adapter cords 320 and 330 of FIGS. 6a and 6b respectively. FIG. 6c shows the front of the fourth female connector 303 and the back of the first activating male fitting 305 of power adapters 320 and 330 of FIGS. 6a and 6b, respectively with hot blade 312 and neutral blade 314. The fourth female connector 303 includes a hot contact slot 322 and a neutral contact slot 324, and the contact slots are continuous and open from the back of the connector 303 (as shown in FIG. 6d).

FIG. 6d shows a perspective view of the back of the fourth female connector 303, with the hot contact slot 322 and neutral contact slot 324, continuous and open from the back as well as in the front as shown in FIG. 6c.

FIG. 6e shows the front of the first activating male fitting 305 that mounts over the fourth female connector 303, (not shown) when powering up the power adapter, either 320 or 330, (not shown) at a power source and includes a hot blade 312 and a neutral blade 314.

FIG. 6f shows a side perspective view of the first activating male fitting 305 with hot blade (prong) 312 and neutral blade (prong) 314, inserted into the fourth female connector 303 of either power adapter cords 320 and 330 (partly shown) of FIGS. 6a and 6b, respectively. Grips 319 allow removal of both connector 303 and activating fitting 305 from a power source when connected and also make separation from each other easier. Strap 325 of the first activating fitting is partly shown.

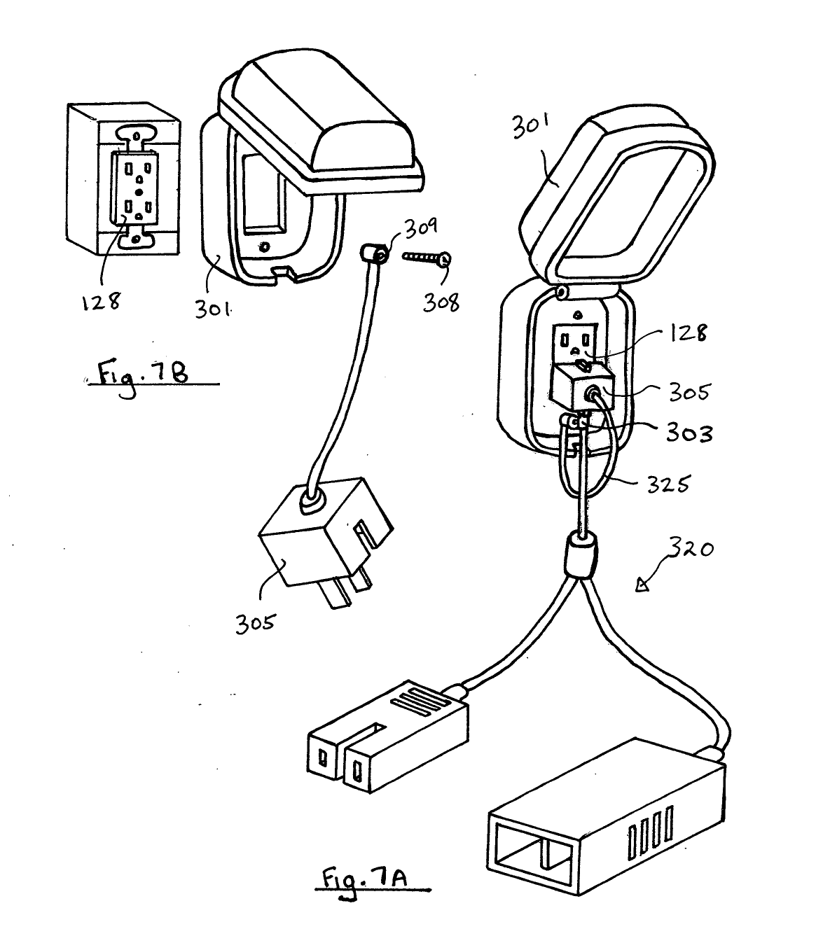

FIG. 7a shows a main power adapter 320 of FIG. 6a that is used to power Christmas lights 5 of cords 33 and 99 (not shown). The power adapter 320 is plugged an electrical power receptacle 128, using the first activating male fitting 305 inserted into the fourth female connector 303. The first activating male fitting includes a safety strap 325 that is secured to an outdoor electrical outlet, which can includes the receptacle 128 and weatherproof cover 301.

FIG. 7b shows an outdoor electrical box with receptacle 128, an outdoor weatherproof cover 301, and the first activating male fitting 305. The first activating male fitting 305 can secure to the cover 301 and receptacle 128, using mount 309 and screw 308 of strap 325 of male fitting 305.

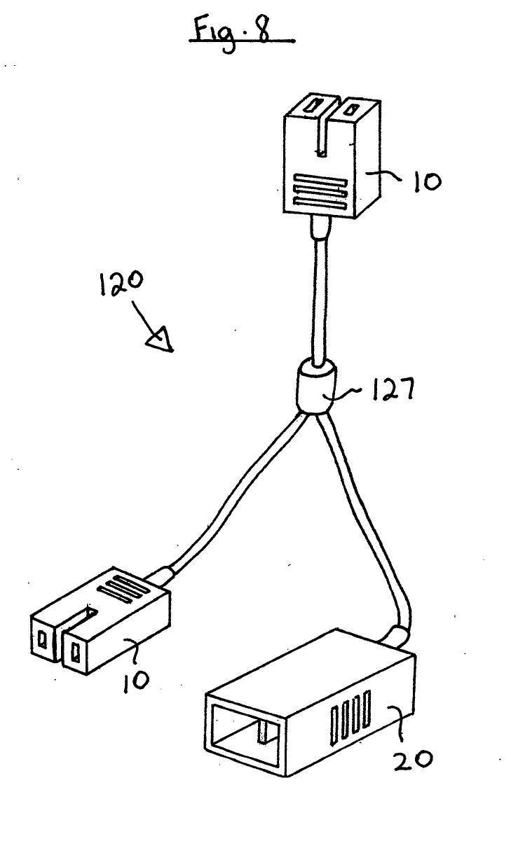

FIG. 8 shows a first embodiment of a splitter adapter cord 120, with a first female connector 10 which is attached by a cord to a splitter 138, that splits to two separate cords, one to a further first female connector 10 and the other a first male connector 20. The splitter adapter 120 allows cords to be run off in different directions. Again, for ease of access, various linking male fittings of the present invention can be secured to the splitter adaptor 120.

FIG. 9 shows a second embodiment of a splitter adapter cord 130, with a second female connector 30 which is attached by a cord to a splitter 127, that splits to two separate cords, one to a further second female connector 30 and the other to a third female connector 40. The splitter adapter 130 allows cords to be run off in different directions. A linking male fitting 70 is used to connector the splitter adapter to the electrical cord of FIG. 2a. Again, for ease of access, various linking male fittings of the present invention can be secured to the splitter adaptor 130.

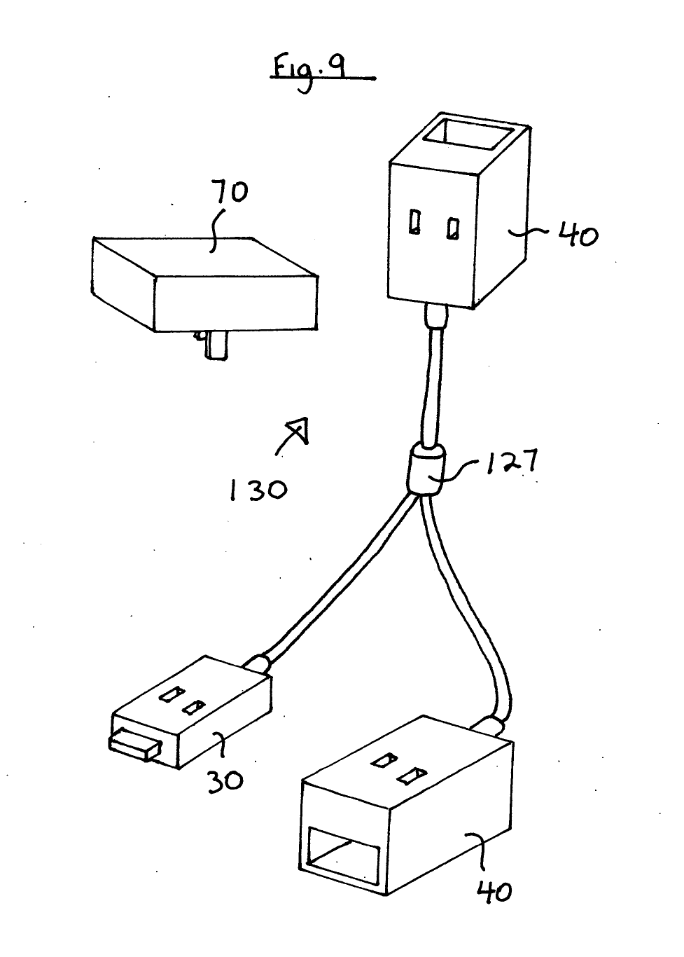

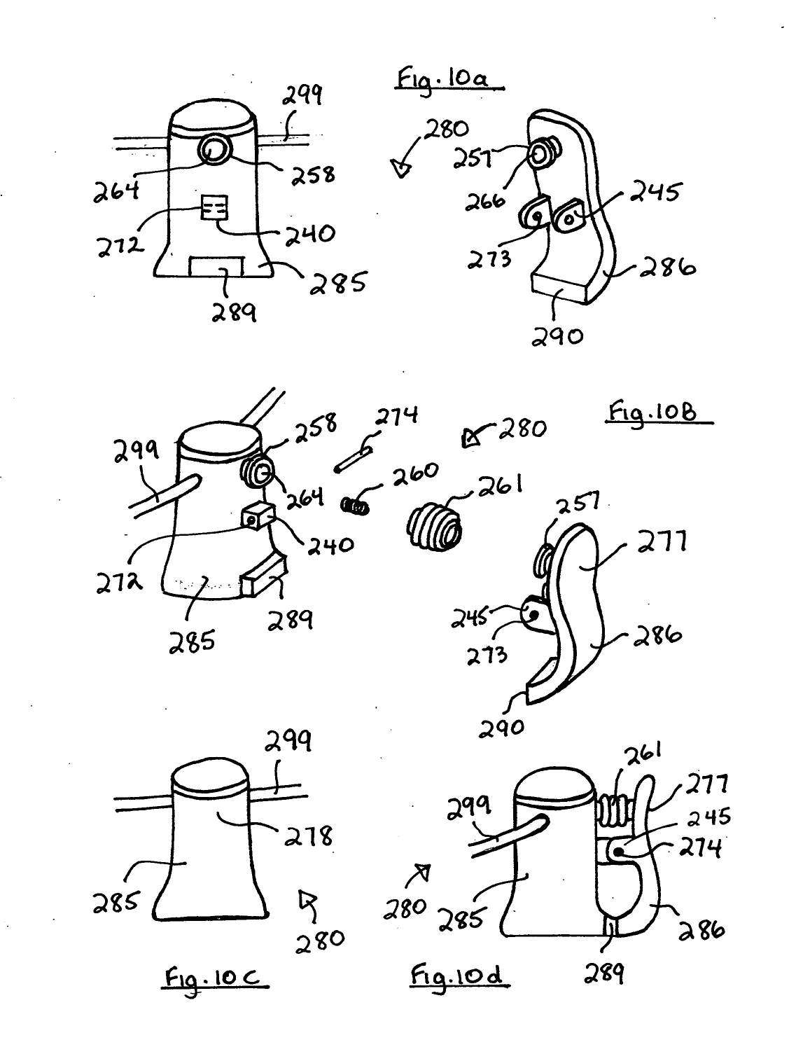

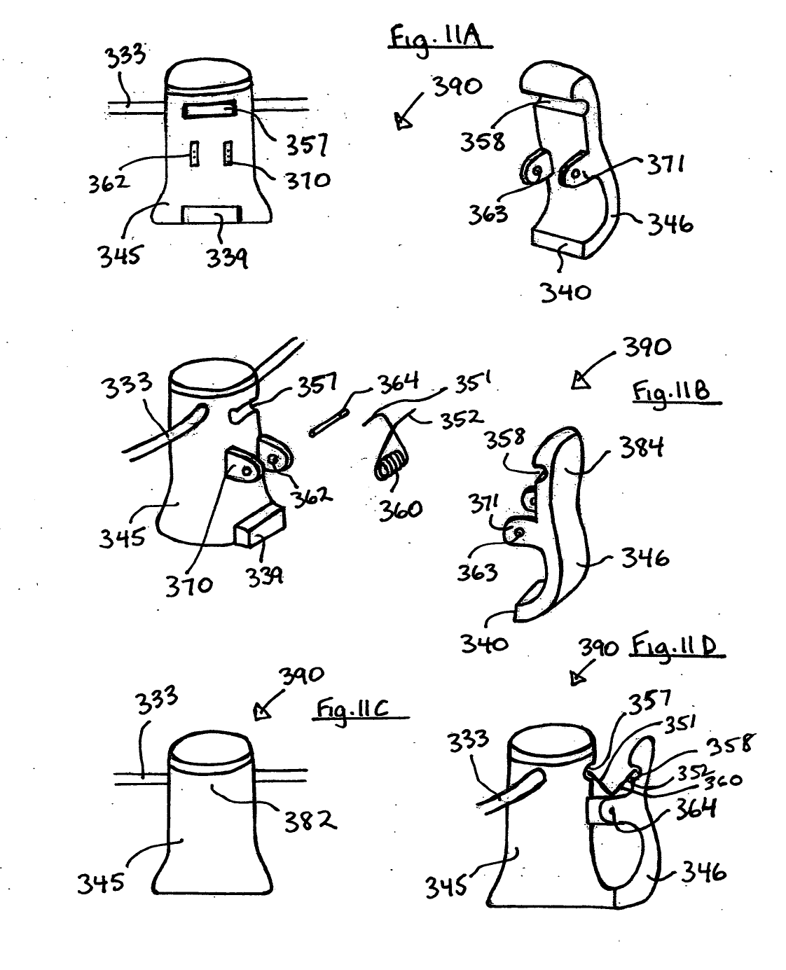

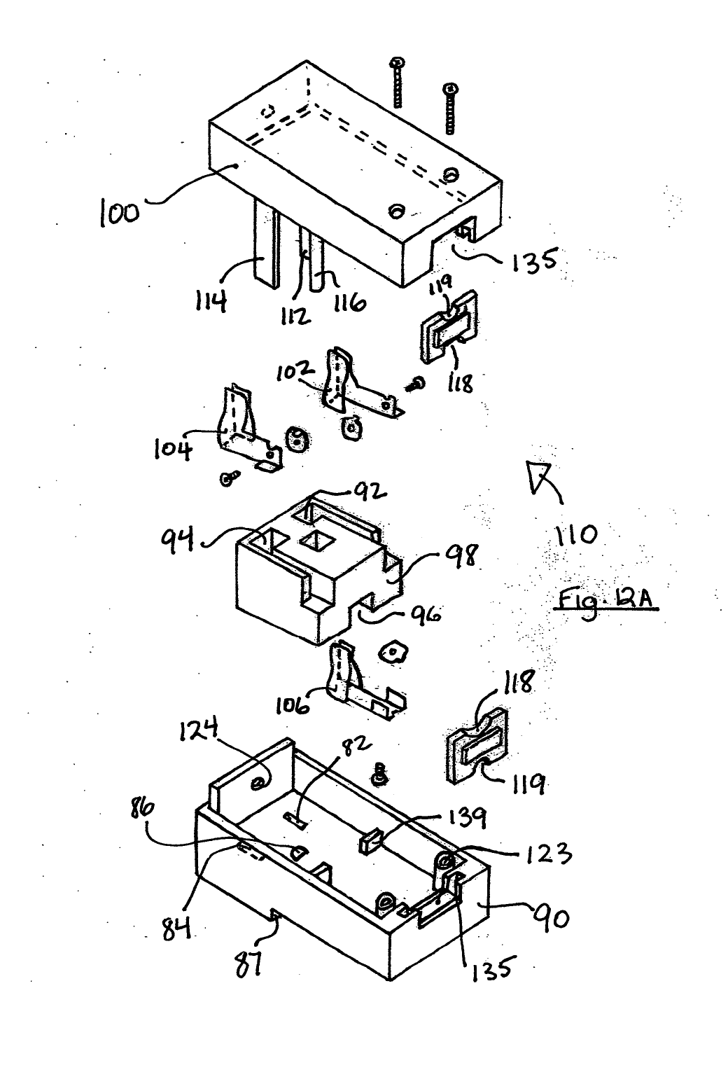

FIGS. 10 and 11 show an improved Christmas light clip, where the light socket is one half of the clip and an elongated body member is the other half.

FIG. 10a shows a first embodiment of two halves of a Christmas light socket clip 280. The Christmas light socket 285, is connected to an electrical cord 299 (partly shown) is one half of the clip and the other half, is an elongated body member 286. The Christmas light socket's outer housing contains a mount 240 for the other half of the clip, the elongated body member 286. The mount includes a mounting hole 272. The Christmas light socket 285 includes a spring housing 264 near the top of the housing directly above the mount 240. The spring housing 264 retains and secures one end of a compression spring 260 (shown in FIG. 10b) and optionally can include an external outer lip 258 for mounting of a rubber boot 261 (shown in FIG. 10b). The Christmas light socket 285 has a gripping portion 289 directly below the housing mount 240 located at the base of the socket.

The elongated body member 286, is the other corresponding half of the Christmas light socket clip 280 and comprises two mounting members 245 for mounting to the side of mount 240 of the Christmas light socket. The two mounting members 245 include a mounting hole 273 for the retaining pin 274 (shown in FIG. 10b), to secure the two mounting members 245 to the sides of mount 240 of the Christmas light socket 285. The elongated body member 286 includes the other half of the spring housing 266 for retaining and securing the other end of a compression spring 260, (shown in FIG. 10b). The spring housing 266 can optionally include an external outer lip 257 for mounting of a rubber boot 261, (shown in FIG. 10 b), corresponding to the outer lip 258 and spring housing 264 of the Christmas light socket 285, and is used for protecting the spring from damaged or corrosion, either from weather or other. The elongated body member 286 includes a gripping portion 290.

FIG. 10b shows and exploded view of the Christmas light socket clip 280 of the present invention and its component parts. One end of a compression spring 260 mounts and secures to the spring retaining housing 264 of the Christmas light socket 285 and to the other end of the compression spring mounts and secures to the spring retaining housing 266 of the elongated body member 286. The spring retaining housings 264 and 266 each include an outer lip 258 and 257 respectively, and the free ends of a rubber boot 261 installs over the outer lips 258 and 257 of the spring retaining housings 264 and 266, respectively. The retaining pin 274 secures the two mounting members 245 of the elongated body member over the sides of the housing mount 240 of the Christmas light socket by entering the hole 273 of one of the mounting members 245 then through the mount 240 and again through the other mounting member 245. The elongated body member 286 includes a finger grip area 277 at the top of the outer area of the elongated body member 286. The Christmas light socket 285 is electrically wired to cord 299 (partially shown).

FIG. 10c shows the back of the Christmas light socket with clip 280 and the wired electrical cord 299 (partly shown). A finger grip 278 is shown near the top of the Christmas light socket 285.

FIG. 10d shows a side view of the Christmas light socket with clip 280 showing the Christmas light socket 285 connected to the elongated body member 286 with retaining pin 274 retaining the mounting members 245 to mount 240 of the socket housing. A rubber boot 261 is installed over the out lips of the clip (not visible) and covers the compression spring 260 (not visible). A side view of the socket gripping portion 289 is seen and a side view of the finger grip 277 of the elongated member 286 is also shown. The Christmas light socket 280 is wired to cord 299 (partially shown).

FIG. 11a shows the two halves of a second embodiment of a Christmas light socket clip 390. The Christmas light socket 345, is connected to electrical cord 333 (partially shown), and is one half of the clip and the other half, is an elongated body member 346. The Christmas light socket's outer housing contains two mounting members 370 for retaining and securing the torsion spring 360 (not shown) and securing to the other half of the clip, an elongated body member 346, using a retaining pin 364 (not shown). The mounting members 370 includes a mounting hole 362. The Christmas light socket includes a groove 357 near the top of the socket housing 345 directly above the two mounting members 370. The groove 357 acts as a rest for one of the arms 351 of the torsion spring 360 (not shown). The Christmas light socket 345 has a gripping portion 339 directly below the two mounting members 370 located at the base of the light socket 345.

The elongated body member 346 (jaw), is the other corresponding half of the Christmas light socket clip 390 and comprises two mounting members 371 for mounting to the side of the two mounting members 370 of the Christmas light socket 345. The two mounting members 371 include a mounting hole 363 for the retaining pin 364 (not shown) to retain the torsion spring 360 and secure to the Christmas light socket. The elongated body member 346 includes a groove 358 near the top of the inside of the elongated body member 346 and directly above the two mounting members 371. The groove 358 acts as a rest for the other arm 352 of the torsion spring 360 (not shown). The elongated body member 346 includes a gripping portion 340. A retaining pin 364 (not shown) enters both mounting holes 363 and 362 of the mounting members 371 and 370, respectively.

FIG. 11b shows and exploded view of the Christmas light socket clip 390 and its component parts of the present invention. A torsion spring 360 is meant to slide between the two mounting members 370 of the Christmas light socket 345, with the spring arm 351 of spring 360 resting on the groove 357 of the Christmas light socket 345 and the other arm of the torsion spring 352 resting on the groove 358 of the elongated body member 346. The mounting members 371 of the elongated body member 346, slides over the outside of the two mounting members 370 of the light socket 345, A retaining pin 364 first enters the mounting hole 363 of the elongated body member 346 then mounting hole 362 of socket housing, through the opening of the torsion spring, again through mounting hole 362 and finally through the other mounting hole 363 of the elongated body member. The Christmas light socket 345 partly shows an electrical cord 333, wired to it. A finger grip 384 is provided on the top outside of the elongated member 346. A socket grip (jaw) 339 is provided at the base of the socket 345 directly below the two mounting members and a contact grip (jaw) 340 is provided on the elongated member 346 for clipping to an object.

FIG. 11c shows the back of the Christmas light socket with clip 390 wired to an electrical cord 333 (partly shown). A finger grip 382 is shown near the top of the Christmas light socket 345.

FIG. 11d shows a side view of the Christmas light socket with clip 390 and its component parts all connected. The retaining pin 364 secures the torsion spring 360, the Christmas light socket 345, and the elongated body member 346 in correct position. The spring arm 351 rests on groove 357 of the light socket 345. The spring arm 352 rests on the groove 358 of the elongated body member 346, (the other half of the clip). A side view of the light socket gripping portion 339 is also shown along with the electrical cord 333 (partly shown).

It will be understood, that both Christmas light socket clips of FIGS. 10 and 11, can be used for other lighting, not just Christmas. Also the two halves of the clip, the socket housing and the elongated body member can have various to provide the proper clipping action required, for various applications. Various materials may be used for the different component parts.

References to “housing” refer to the appropriate molded and accessible housing combination that may be used in the invention depending on the need to access the electrical receptacle.

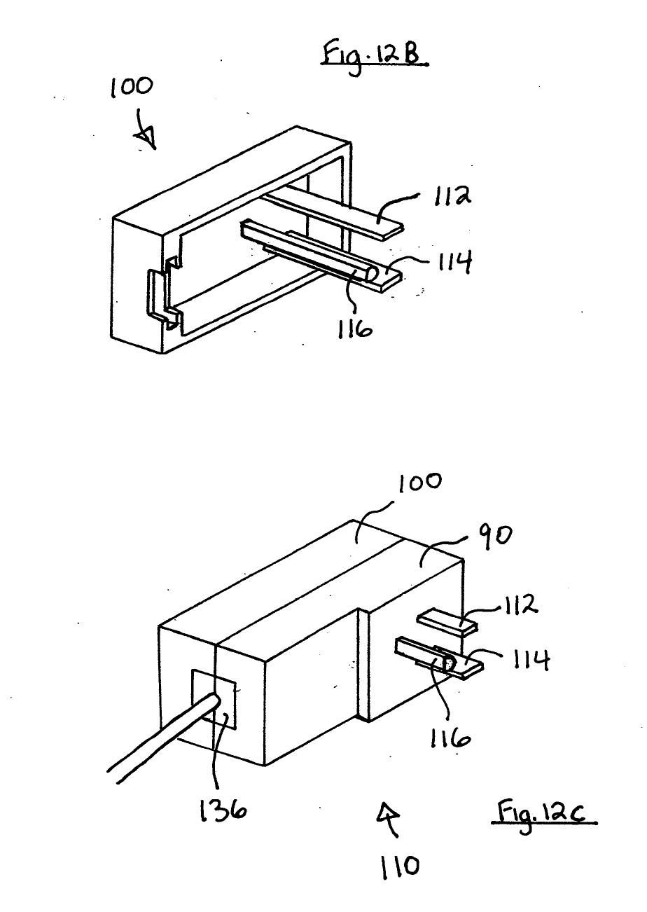

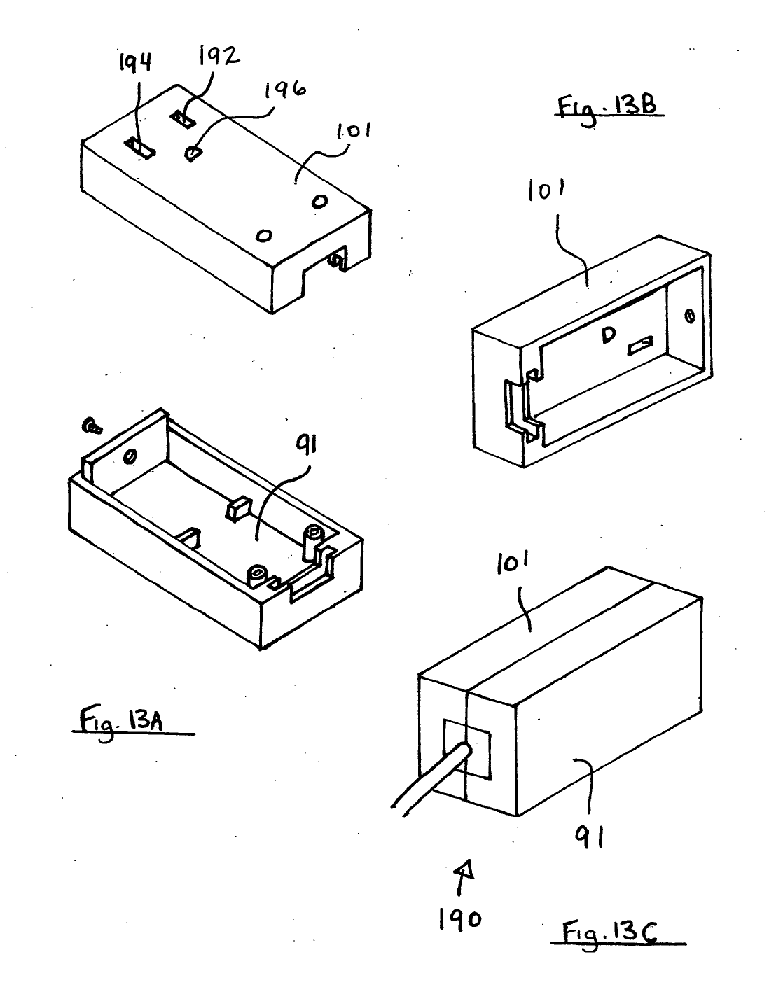

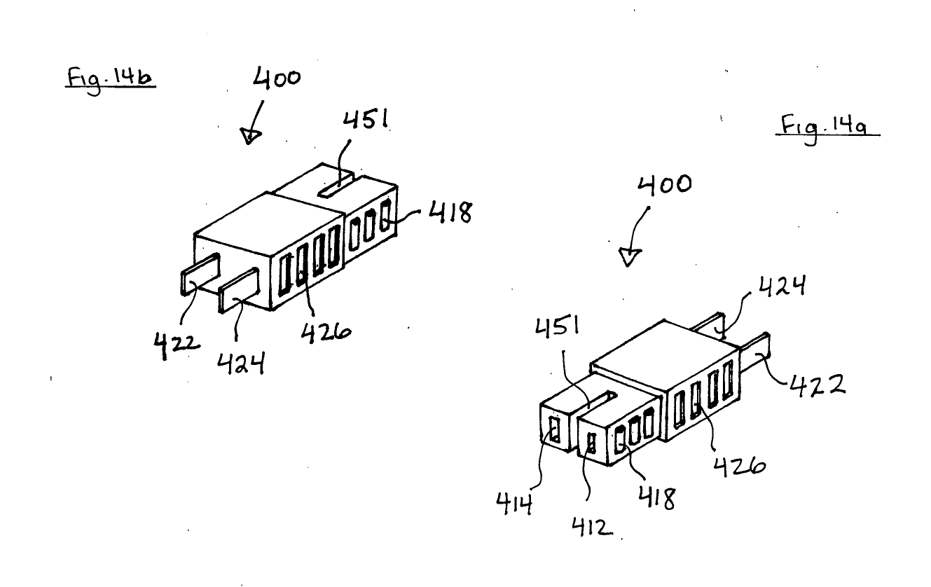

FIGS. 12 and 13 refer to an adaptable replacement connector because the inner component parts are common to both a male and female connector. FIG. 12 refers to a male replacement connector and FIG. 13 refers to a female replacement connector.

FIG. 12 shows a first adaptable male replacement connector 110 with a replaceable cover 100 and a first mounting base 90. The adaptable replacement connector includes an inner housing 98 for the contacts slots/terminals of the connector. A hot contact slot with terminal 102, a neutral contact slot with terminal 104 and ground contact slot with terminal 106, are all housed in the inner housing 98, corresponding to housing slot 92, 94 and 96, respectively. A mounting base 90 includes a body members 139, and provides a slot to position and secure the inner housing and housing components. The mounting base includes openings 82, 84 and 86 for the hot blade 112, the neutral blade 114, and the ground prong 116 of the male replacement cover 100, and provide a tight fit. The mounting base 90 also provides threaded cylinders 123 and threaded bore 124 for the male replacement cover 100 to secure to, using holes 133 on the top and hole 134 on the end, respectively, with screws 126 and 128, respectively. The outside surface of the mounting base 90 includes a extending member 87 for the hot blade 112, neutral blade 114 and ground prong 116 of the male replacement cover to provide them with extra support. Both the mounting base 90 and the replacement cover 100 include a slot 135 for the cord inserts 136. The cord inserts 136 are reversible, and include a top rounded edge 118 and a bottom rounded edge 119 for a big gauge electrical cord or a smaller gauge electrical cord, respectively. The rounded edge 118 and 119 provided the entry of the electrical cord to be wired to the male replacement connector. The contact slots 92, 94 and 96 are open from the back and allow the hot blade 112, neutral blade 114 and ground prong 116 to pass through, and exit the mounting base 90. The connector provides easy replacement of the cover if any blades or ground prong become damaged without requiring any rewiring.

The mounting base can provide internal guide rails, ie a bevel to guide the blades and prong(s) to exit the contact slots of the mounting base 90, and provides a tight fit of the blades/prongs, similar to conventional plugs.

FIG. 13a-13c shows perspective view of adaptable female replacement connector or parts of the replacement connector. The adaptable female replacement connector uses the same internal housing of the adaptable male replacement connector of FIG. 12a, which includes the housing and the electrical contacts slots that are combined with the electrical terminals.

FIG. 13a shows the adaptable female replacement cover 101, and mounting base 91 of the adaptable female replacement connector of FIG. 13c. The adaptable female replacement cover 101, includes openings 192, 194 and 196, to correspond with the hot contact 102, the neutral contact 104 and the ground contact 106 of the inner housing 98 as shown in FIG. 12a. The mounting base has no slot openings as in the male mounting base in FIG. 12a.

FIG. 13b shows a perspective view of the inside of the adaptable female replacement cover 101.

FIG. 13c shows an adaptable female replacement connector 190 wired to an electrical cord. Both the replacement cover 101 and mounting base are secured in the same way as the adaptable male replacement connector of FIG. 12a.

Both adaptable replacement connectors of FIGS. 12 and 13 can additionally be colored coded for ease of recognizing a connector meant for a male connector or female replacement connector. Also, both adaptable replacement connectors of FIGS. 12 and 13 can be applied for various applications, including a connectors with or without a ground prong and connector with more than two blades, plus prong as in a connector with more than one hot contact.

FIGS. 14a and 14b shows a first embodiment connector adapter 400 comprising a female end and a male connector end of the first female connector 10 and first male connector 20 of FIG. 1a respectively, connected and linked together.

FIG. 14a shows a back side view of the adapter 400 with a female connector end comprising a hot contact slot 412 and a neutral contact slot 414, connected to the hot prong 422 and the neutral prong 424, respectively, of the male connector end. The female connector end includes slot 451 in the housing between the hot and neutral slots. Slot 451 corresponds to partition tab 53 of the first male connector 20 of FIG. 1a. The adapter also includes grips 418 on the female end, on the sides for gripping the inside of the receiving port of the first male connector 20 when connected together. The male connector end includes grips 426 for gripping the adapter when disconnecting it from a first female connector 10 or when unplugging it from an electrical outlet or electrical cord.

FIG. 14b shows a front side view of the adapter 400 with a male connector end comprising a hot prong 422 and a neutral prong 424, connected to the hot contact slot 412 and the neutral contact 414, respectively, (both not shown), of the female connector end. The male connector end shows grips 426 and the female connector end includes grips 418. A slot 451 is provided in the housing between the hot and neutral contact slots, to correspond to first male connector of FIG. 1a.

The blades of conventional male plugs can break or bend such that they are unusable. A plug with a ground prong when a ground is present, may still function, but is unsafe to use. If the ground prong of the linking and/or activating male fittings of the present invention break, a new activating male fitting can easily be replaced since the blades and ground prong of the male fitting is not attached to any electrical terminal(s) of the connector.

It will be understood that the figures show no contact slot for a ground in some examples and a contact slot for a ground in other examples, and it will be understood that either can be used depending on the needs. As well, just as with conventional cords, the connectors of the present invention can be for interior or exterior use. It will be understood that the prongs and contact slots can be adapted depending on the country's electrical conventions/needs, and the examples show North American standards just for illustration purposes but the invention is not limited to same.

Female receptacles on connectors, splitter cords, and adapter cords can be staggered, have various sizes, blades/prongs design, spacing, and length and depth of contact slots, and match the design of the blades/prongs of its corresponding male fitting.

The Christmas lights cord connectors and various adapter connectors can be made of various thickness to be able to accept other electrical cords with regular size plugs or made to be thinner and less bulky, and designed with safety in mind, in accidental misuse. Since outdoor electrical cords should be plugged into gfci outlets, the main power adapter cord can include a built-in gfci for extra electrical safety. Of course, all electrical cords can vary in length, and have various components. The wiring, connector ends, fittings and adapters can be for a two or more prong circuit with or without ground wire designed for use in multiple countries and for the specific voltage used in those countries.

The connectors and adapters of the present invention can be used with various interior or exterior electrical cords, including cords for lighting with various numbers of incandescent bulbs, LED'S, ornamental lights, or electrical decorations on the electric cord and between the connectors or adapters, just as with conventional connectors.

A plug or sleeve cover can be installed over any connector when not in use to protect from damage.

While embodiments of the invention have been described in the detailed description, the scope of the claims should not be limited by the preferred embodiments set forth in the examples, but should be given the broadest interpretation consistent with the description as a whole.

The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

What is claimed:

1. The electrical cord comprises one or more lights attached between the first female connector on a first end and a first male connector on the second end; said first female connector comprising a receptacle with a first hot a neutral contact slot; said first male connector comprising a first hot and neutral blade with a receiving port; said receiving port sized to receive the first female connector within it.

2. An electrical cord with a second female connector on a first end and a third female connector on a second end; and a linking male fitting;
said second female connector comprises a second electrical receptacle with a second hot contact slot and a second neutral contact slot; said third female connector comprises a third electrical receptacle,
said third electrical receptacle having a third hot contact slot and a third neutral contact slot, wherein the third hot contact slot and the third neutral contact slots are continuous and additionally open to a receiving port below;
said receiving port is sized to receive the second female connector within it;
said linking male comprising a top and four sides and a hot blade and a neutral blade; said hot and neutral blade attached to the top and pointing out.

3. A holiday lighting clip located on a string of Christmas lights comprising a light socket outer housing form one half of the clip and an elongated body member forming the other half.
